(19) United States
(12) Patent Application Publication
(10) Pub. No.: US 2021/0101779 A1
(43) Pub. Date: Apr. 8, 2021

(54) ELEVATOR-BASED AUDIO/VIDEO/TEXTING EMERGENCY COMMUNICATIONS SYSTEM

(71) Applicants: Steven P. Wurth, Sylvania, OH (US); Terry Rodebaugh, Whitehouse, OH (US); Mike Churski, Lambertville, MI (US)

(72) Inventors: Steven P. Wurth, Sylvania, OH (US); Terry Rodebaugh, Whitehouse, OH (US); Mike Churski, Lambertville, MI (US)

(21) Appl. No.: 17/064,047

(22) Filed: Oct. 6, 2020

Related U.S. Application Data
(60) Provisional application No. 62/911,506, filed on Oct. 7, 2019.

(51) Int. Cl. B66B 1/34; B66B 5/00; B66B 3/00

(52) U.S. Cl. CPC B66B 1/3461; B66B 3/008; B66B 5/0012

(57) ABSTRACT

An elevator-based audio/video/texting emergency communications system configured to facilitate communication between passengers within an elevator car and designated emergency service providers is provided. The system includes cameras located within the elevator car. The cameras observe an interior space of the elevator car. Speakers are located within the elevator car and broadcast audio communication. Microphones are located within the elevator car and transmit audio communication from passengers. Displays located within the elevator car facilitate two-way text communication with elevator car passengers. A processor assembly receives communication from the cameras, speakers, microphones and displays, and processes the electrical communications for connection with other devices. An elevator car ethernet adapter receives communication from the processor assembly. A building ethernet adapter receives communication from the elevator car ethernet adapter. An ethernet switch receives communication from the elevator car ethernet adapter and connects to peripheral communications systems, thereby forming a local area network.

### RELATED APPLICATIONS

This application claims the benefit of pending U.S. Provisional Patent Application No. 62/911,506, filed Oct. 7, 2019, the disclosure of which is incorporated herein by reference in its entirety.

### BACKGROUND

An elevator, lift or escalator is a vertical transport vehicle that efficiently moves people or goods between floors of a building. Elevators or lifts are generally powered by electric motors that either drive traction cables and counterweight systems, or pump hydraulic fluid to raise a cylindrical piston. An escalator is a moving staircase consisting of an endlessly circulating belt of steps driven by a motor and configured to convey people between the floors of a building.

The construction, operation, inspection, testing, maintenance, alteration, and repair of elevators, lifts or escalators are typically governed by one or more code authorities. The code authorities can be government based or industry based. Non-limiting examples of an industry-based code include ASME A17.1-2019.—Safety Code for Elevators and Escalators and CSA B44-2019.

Recent revisions to ASME A17.1-2019 and CSA B44-2019 involve the inclusion of code compliant emergency audio, video and text communications between passengers trapped in an elevator and designated emergency service providers, call centers and the like. It would be advantageous if elevator communication systems could be improved to meet the newer code requirements.

### SUMMARY

It should be appreciated that this Summary is provided to introduce a selection of concepts in a simplified form, the concepts being further described below in the Detailed Description. This Summary is not intended to identify key features or essential features of this disclosure, nor it is intended to limit the scope of the elevator-based audio/video/texting emergency communications system.

The above objects as well as other objects not specifically enumerated are achieved by an elevator-based audio/video/texting emergency communications system configured to facilitate communication between passengers within an elevator car and designated emergency service providers. The elevator-based audio/video/texting emergency communications system includes one or more cameras located within the elevator car. The one or more cameras are configured to observe an interior space of the elevator car. One or more speakers are located within the elevator car and are configured to broadcast audio communication from designated emergency service providers. One or more microphones are located within the elevator car and are configured to transmit audio communication from passengers within the elevator car. One or more displays are located within the elevator car and are configured to facilitate two-way text communication between designated emergency service providers and passengers located within the elevator car. A processor assembly is configured to receive communication from the one or more cameras, speakers, microphones and displays, and further configured to process the electrical communications thereby allowing electrical connection with other devices. An elevator car ethernet adapter is configured to receive communication from the processor assembly. A building ethernet adapter is configured to receive communication from the elevator car ethernet adapter. An ethernet switch is configured to receive communication from the elevator car ethernet adapter and further configured to connect to various peripheral communications systems, thereby forming a local area network.

The above objects as well as other objects not specifically enumerated are also achieved by an elevator-based audio/video/texting emergency communications system configured to facilitate communication between passengers within an elevator car and designated emergency service providers, the system includes one or more cameras located within the elevator car and configured to observe an interior space of the elevator car. One or more speakers are located within the elevator car and configured to broadcast audio communication from designated emergency service providers. One or more microphones are located within the elevator car and configured to transmit audio communication from passengers within the elevator car. One or more displays are located within the elevator car and configured to facilitate two-way text communication between designated emergency service providers and passengers located within the elevator car. A processor assembly is configured to receive communication from the one or more cameras, speakers, microphones and displays, and further configured to process the electrical communications thereby allowing electrical connection with other devices. A cellular modem configured to receive communication from the processor assembly and further configured to connect to various peripheral communications systems, thereby forming a local area network.

The above objects as well as other objects not specifically enumerated are also achieved by a method of operating an elevator-based audio/video/texting emergency communications system configured to facilitate communication between passengers within an elevator car and designated emergency service providers. The method includes observing an interior space of an elevator car with one or more cameras located within the elevator car, broadcasting audio communication from designated emergency service providers with one or more speakers located within the elevator car, transmitting audio communication from passengers within the elevator car with one or more microphones located within the elevator car, communicating text between designated emergency service providers and passengers located within the elevator car with one or more displays located within the elevator car, receiving communication from the one or more cameras, speakers, microphones and displays with a processor assembly, thereby allowing electrical connection with other devices, receiving communication from the processor assembly with an elevator car ethernet adapter, receiving communication from the elevator car ethernet adapter with a building ethernet adapter and receiving communication from the elevator car ethernet adapter with an ethernet switch and connecting to various peripheral communications systems, thereby forming a local area network.

Various objects and advantages of the elevator-based audio/video/texting emergency communications system will become apparent to those skilled in the art from the following Detailed Description, when read in light of the accompanying drawings.

### BRIEF DESCRIPTION OF THE DRAWINGS

FIG. 1 is a schematic overview of a first embodiment of an elevator-based audio/video/texting emergency communications system in accordance with the invention.

FIG. 2 is a schematic detailed view of the first embodiment of the elevator-based audio/video/texting emergency communications system of FIG. 1.

FIG. 3 is a front view of a car operating panel of the elevator-based audio/video/texting emergency communications system of FIG. 1.

FIG. 4 is a front view of a speaker, microphone and touchscreen display configured mounting to an interior surface of an elevator car as discrete elements of the elevator-based audio/video/texting emergency communications system of FIG. 1.

FIG. 5 is a schematic view of operation of the elevator-based audio/video/texting emergency communications system of FIG. 1.

FIG. 6 is a schematic view of a second embodiment of an elevator-based audio/video/texting emergency communications system.

FIG. 7 is a schematic view of operation of the elevator-based audio/video/texting emergency communications system of FIG. 6.

### DETAILED DESCRIPTION

The elevator-based audio/video/texting emergency communications system (hereafter “communications system”) will now be described with occasional reference to the specific embodiments. The communications system may, however, be embodied in different forms and should not be construed as limited to the embodiments set forth herein. Rather, these embodiments are provided so that this disclosure will be thorough and complete, and will fully convey the scope of the communications system to those skilled in the art.

Unless otherwise defined, all technical and scientific terms used herein have the same meaning as commonly understood by one of ordinary skill in the art to which the communications system belongs. The terminology used in the description of the communications system herein is for describing particular embodiments only and is not intended to be limiting of the communications system. As used in the description of the communications system and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the communications system. Notwithstanding that the numerical ranges and parameters setting forth the broad scope of the communications system are approximations, the numerical values set forth in the specific examples are reported as precisely as possible. Any numerical values, however, inherently contain certain errors necessarily resulting from error found in their respective measurements.

The description and figures disclose several embodiments of a communications system configured for use in an elevator. More specifically, the communications system is configured with code compliant emergency audio, video and text elements, each configured to facilitate communication between passengers within the elevator and designated emergency service providers. Generally, the various embodiments provide systems to monitor the status of the space within an elevator car and also provide systems to communicate with passengers within an elevator car. A first embodiment discloses a cloud-based, hard-wired communications system. A second embodiment discloses a cloud-based, wireless communications system.

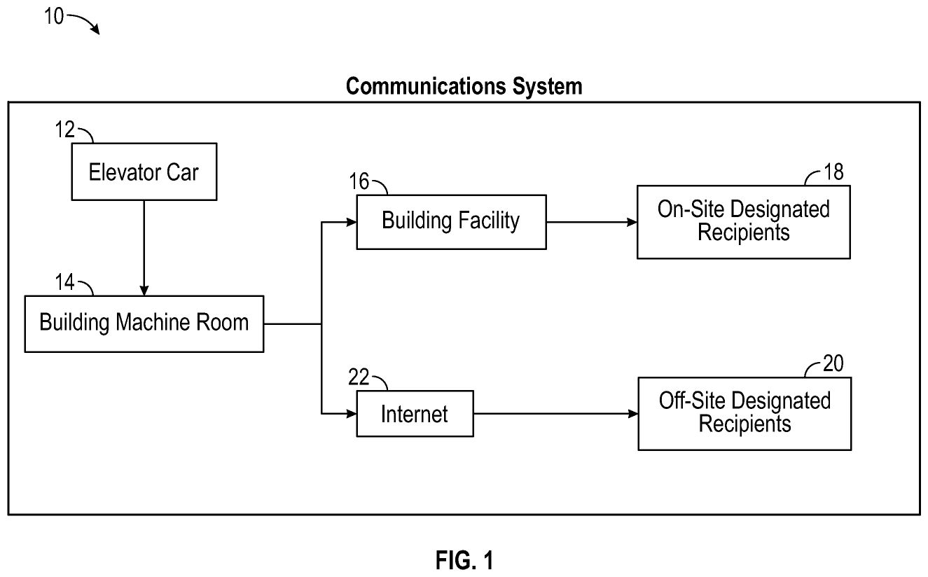

Referring now to FIG. 1, there is illustrated a schematic overview of a communications system 10. Generally, the communications system 10 includes the placement of various apparatus within the interior of the elevator car 12, on or about the elevator car 12, within a building machine room 14 and within a building facility 16. The term “building machine room”, as used herein, is defined to mean any room or space within a building configured for the storage or installation of mechanical or electrical/electronic elevator-related devices. The term “building facility”, as used herein, is defined to mean any room or space with a building.

Referring again to FIG. 1, generally information and communications originating from within the elevator car 12 are conveyed to the building machine room 14, and in turn, are conveyed to designated building-related recipients 18 for action. The information and communications originating from within the elevator car 12 can also be conveyed to other designated recipients 20 via other communications systems, such as the non-limiting example of the internet-based systems 22. As will be explained in more detail below, the communications system 10 is configured to provide responsive communication from the designated recipients 18, 20 to the passengers within the elevator car 12.

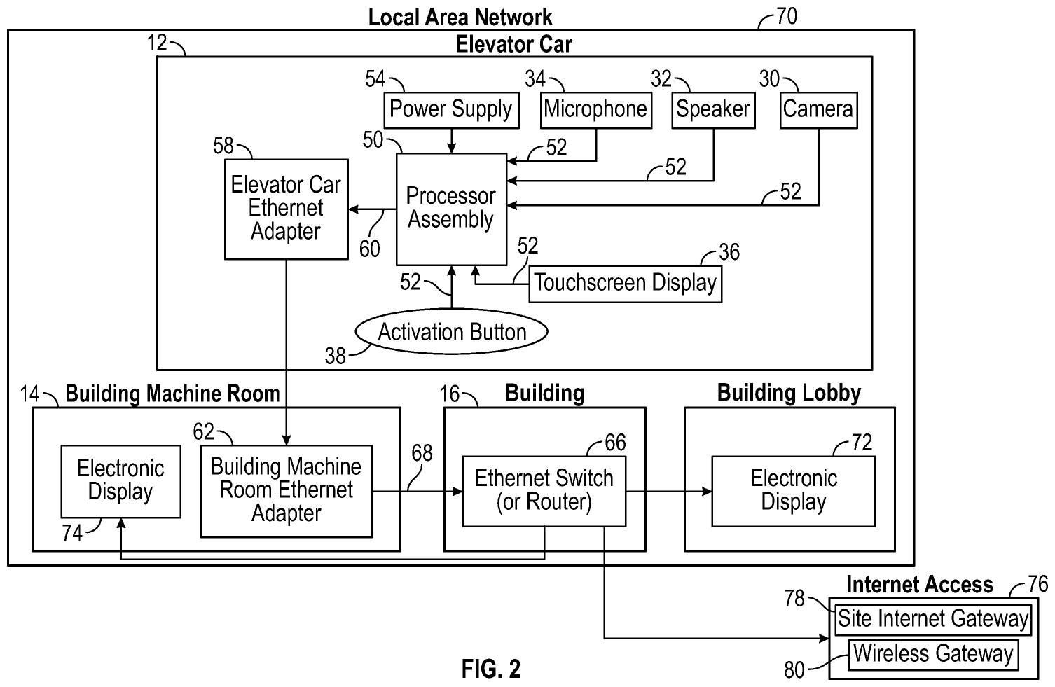

Referring now FIG. 2, a diagrammatic and simplified view of a first embodiment of the communications system 10 is illustrated. The first embodiment of the communications system 10 is a cloud-based, hard-wired communications system. The term “hard-wired”, as used herein, is defined to mean the various surveillance and communications systems contained in the elevator car 10 are connected to apparatus in the building machine room 14 by electrical wires or cables. The communications system 10 includes a camera 30, located in the elevator car 12 and configured to observe the interior floor space of the elevator car 12. In certain instances, the camera 30 is conventional in the art and has the form of a real-time video camera. In other instances, other cameras can be used sufficient to observe the interior floor space of the elevator car 12.

Referring now to FIGS. 1 and 2, two-way audio communication is facilitated between passengers within the elevator car 12 and designated recipients 18, 20 through a speaker 32 and microphone 34 mounted within the interior of the elevator car 12. A touchscreen display 36 is also located within the interior of the elevator car 12 and is configured to allow two-way text communication between designated recipients 18, 20 and hearing-impaired passengers located within the interior of the elevator car 12. In the illustrated embodiment, the touchscreen display 36 has the form of a liquid crystal display (LCD). However, in other embodiments, the touchscreen display 36 can have other forms sufficient to allow two-way text communication between designated recipients 18, 20 and hearing-impaired passengers located within the interior of the elevator car 12. The speaker 32, microphone 34 and touchscreen display 36 are conventional in the art and are configured to provide the required audio and visual interface with passengers within the interior of the elevator car 12 to the designated recipients 18, 20.

Referring now to FIG. 2, the communication system 10 also includes a plurality of activation devices 38 configured to facilitate responses from hearing-impaired passengers located within the interior of the elevator car 12. In certain instances, the plurality of activation devices 38 have the form of buttons that can include the non-limiting examples of a “yes” button indicating a positive response and a “no” button indicating a negative response. In other instances, other buttons can be provided including the non-limiting examples of a “help” button and a “place call” button configured to initiate a call. In alternate embodiments, the plurality of activation devices 38 can have other forms and can include other distinct devices configured for other responses and other purposes.

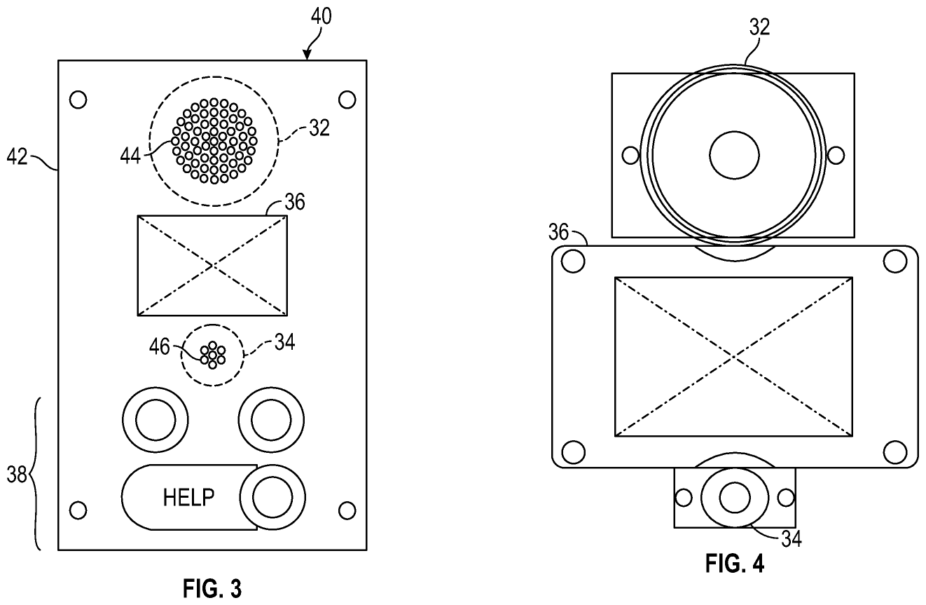

It is contemplated that in certain instances, the speaker 32, microphone 34, touchscreen display 36 and plurality of activation devices 38 can be grouped together in a car station, positioned within the elevator car 12. Referring now to FIG. 3 a first embodiment of a car station is illustrated at 40. The car station 40 is mounted over, or flush to, an interior surface within the interior of the elevator car 12, thereby exposing the speaker 32, microphone 34, touchscreen display 36 and plurality of activation devices 38 to the passengers within the elevator car 12. Suitable interior surfaces include front returns adjacent an elevator door. The car station 40 includes a mounting plate 42, the speaker 32 mounted behind a speaker grid 44, the microphone 34 mounted behind a microphone grid 46, the touchscreen display 36 and the plurality of activation devices 38.

Referring now to FIG. 4, it is further contemplated that each of the speaker 32, microphone 34 and touchscreen display 36 can be mounted to an interior surface of the elevator car 12 as discrete elements and without grouping in a car station. In this embodiment, the plurality of activation devices (not shown) are positioned in a conventional car operating panel.

Referring again to FIG. 2, the camera 30, speaker 32, microphone 34 and touchscreen display 36 are in electrical communication with a processor assembly 50 via electrical connectors 52. The processor assembly 50 is configured to receive electrical communications from the camera 30, speaker 32, microphone 34 and touchscreen display 36 and is further configured to process the electrical communications thereby allowing electrical connection with other devices over a local area network (LAN) or the internet. In the illustrated embodiment, the processor assembly 50 has the form of a single board computer. The term “single board computer”, as used herein, is defined to mean any complete computer built on a single circuit board, with a plurality of microprocessors, memories, input/output functions and other features required of a functional computer. The use of a single board computer, contained within a small and compact package, advantageously facilitates positioning of the processor assembly 50 on the elevator car 12. However, it is contemplated that in other embodiments, the processor assembly 50 can have other forms sufficient to receive electrical communications from the camera 30, speaker 32, microphone 34 and touchscreen display 36 and process the electrical communications thereby allowing electrical connection with other devices over a local area network (LAN) or the internet. In the illustrated embodiment, the electrical connectors 52 have the form of universal serial bus (USB) connectors. However, in alternate embodiments, the electrical connectors 52 can have other forms sufficient to convey electrical communications from the camera 30, speaker 32, microphone 34 and touchscreen display 36 to the processor assembly 50.

Referring again to FIG. 2, the communications system 10 also includes an emergency power supply 54. The emergency power supply 54 is configured to provide sufficient electrical power to power the camera 30, speaker 32, microphone 34, touchscreen display 36 and the processor assembly 50 in the event of a disruption of a primary power supply. In the illustrated embodiment, the emergency power supply 54 has the form of a 5.0 volt D.C. uninterruptable power supply (UPS). The term “uninterruptable power supply”, as user herein, is defined to mean any electrical apparatus that provides near-instantaneous protection from input power interruptions when the input or primary power source fails.

Referring again to FIG. 2, the processor assembly 50 is in electrical communication with an elevator car ethernet adapter 58 via electrical connector 60. The elevator car ethernet adapter 58 is configured to receive electrical communications from the processor assembly 50 and is further configured to connect the processor assembly 50 with internet functions. In the illustrated embodiment, the elevator car ethernet adapter 58 is a high-speed serial adapter. However, in other embodiments, the elevator car ethernet adapter 58 can have other forms sufficient for the functions described herein.

Referring again to FIG. 2, the elevator car ethernet adapter 58 is connected to a building machine room ethernet adapter 62 by electrical connector 64. The electrical connector 64 is configured to provide electrical communication between the elevator car ethernet adapter 58 and the building machine room ethernet adapter 62. In the illustrated embodiment, the electrical connector 64 is a dedicated pair of electrical wires. In alternate embodiments, the electrical connector 64 can be other structures, mechanisms and devices sufficient to facilitate electrical communication between the elevator car ethernet adapter 58 and the building machine room ethernet adapter 62. In the illustrated embodiment, the building machine room ethernet adapter 62 is a high-speed serial adapter. However, in other embodiments, the building machine room ethernet adapter 62 can have other forms sufficient for the functions described herein.

Referring again to FIG. 2, the combination of the electrically connected elevator car ethernet adapter 58 and building machine room ethernet adapter 62 are configured to form a closed local area network (LAN).

Referring again to FIG. 2, the building machine room ethernet adapter 62 is electrically connected to a building ethernet switch (or router) 66 via electrical connector 68. The building ethernet switch 66 is configured to connect the building machine room ethernet adapter 62 to various peripheral communications systems, thereby forming a local area network 70. Non-limiting examples of peripheral communications systems include digital displays located in a building lobby 72, digital displays 74 located in the building machine room 14 and systems accessed through internet connections 77.

Referring again to FIG. 2, internet access 76 can be accomplished either from a site internet gateway 78 or from a wireless gateway 80. Once connected to the local area network 70 or internet, the communication system 10 will call designated recipients via a peer-to-peer (P2P) software application running on a local device or internet connected devices registered with the communications system 10.

Referring again to FIG. 2, per recent code changes, communications from within the elevator car 12 to the designated recipients 18, 20 are initiated via the plurality of activation devices 38. Local area network 70 and internet 76 connected devices will also be able to make calls to the elevator car 12.

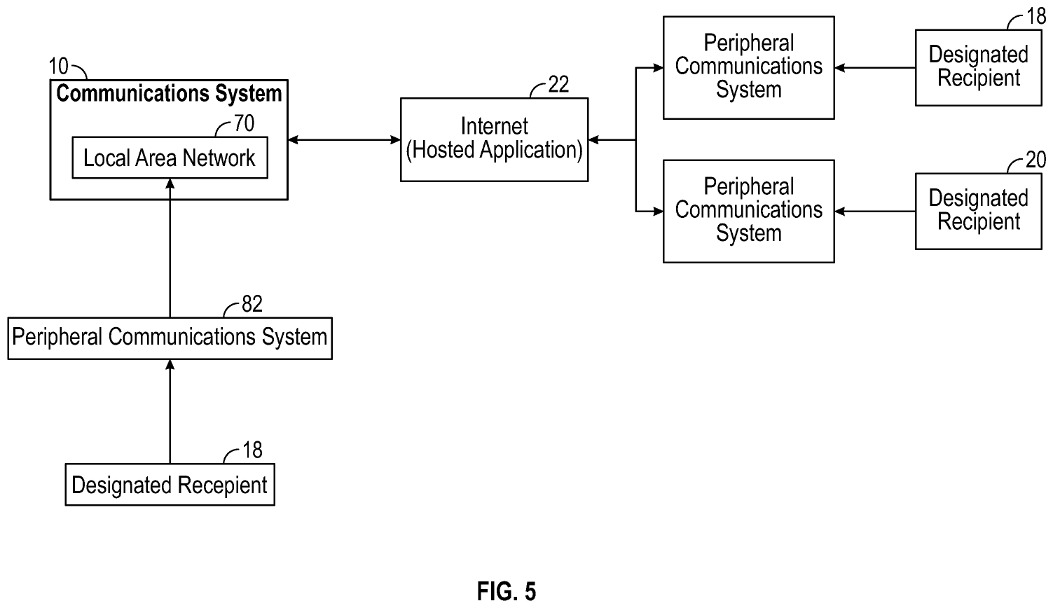

Referring now to FIG. 5, in operation, a peripheral communications system 82, such as the non-limiting examples of a laptop computer or tablet, equipped with proprietary software, can be connected to local area network 70 of the communications system 10 and can act as a user interface for designated recipients 18, 20 to receive real time video, information and communications originating from within the elevator car 12 and communicate to passengers located in the elevator car 12. The peripheral communications system 82 can be configured to show real-time video of the interior of the elevator car 12 and can be further configured to allow two-way audio and text. The local area network can then either be connected to the site internet gateway 78, if granted permission from network administrators, or to a wireless gateway 80 to gain access to the internet 22.

Referring again to FIG. 5, it should be appreciated that the communications system 10 can be operated with or without an internet connection. In operation without an internet connection, the peripheral communications system 82 is located within the building facility 16. It is further contemplated that the communications system 10 can communicate with multiple peripheral communications systems 82 and further can communicate with more than one elevator car 12 simultaneously. It is further contemplated that the communication system 10 is configured to join existing on-going sessions between multiple elevators.

Referring again to FIG. 5, with an internet connection, communications can be established with off-site designated recipients in locations such as call centers or maintenance service providers. Off-site designated recipients are able to initiate or receive communications with the communications system 10 using a web browser and minimal system configuration.

Referring again to FIG. 5, the hosted application 22 includes a web server that provides client-side content over HyperText Transfer Protocol (HTTPS) and signaling between clients via a secure websockets server. The client-side content shall consist of Hypertext Markup Language (HTML), Cascading Style Sheets (CSS) and JavaScript components responsible for the formatting and presentation of the web page. The secure websockets server provides a means for browser-based endpoints to chat, initiate calls, end calls, determine connection status etc. In addition, a login server, firewall traversal and a Public Switched Telephone Network (PSTN)/cellular network gateway interface will be required.

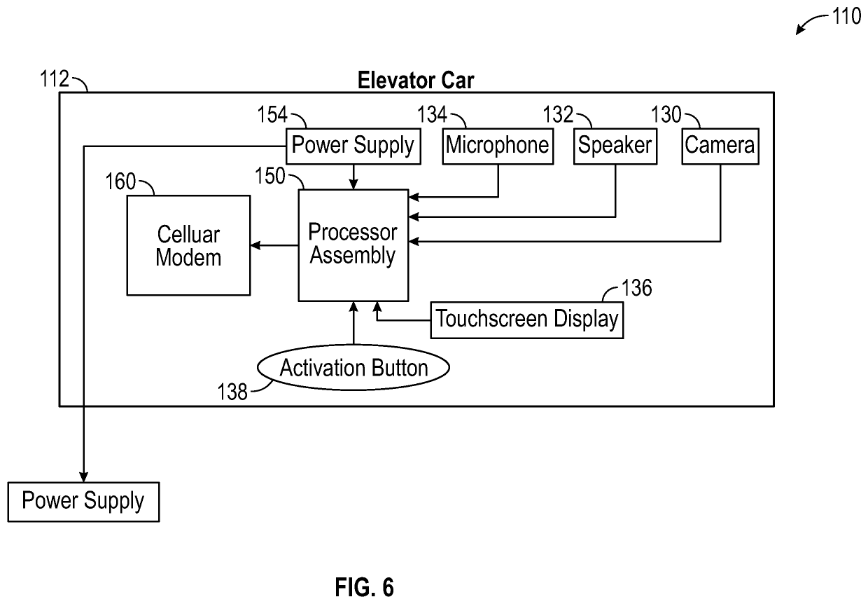

While the communication system 10 described above and shown in FIG. 2 includes the use of a hard-wired electrical connector 64 to gain access to the internet by electrically connecting the elevator car ethernet adapter 58 to the building machine room ethernet adapter 62 and the building ethernet switch, it is contemplated that in other embodiments the communications system can employ other structures, mechanisms and devices to gain access to the internet by wireless methods. Referring now to FIG. 6, a second embodiment of a communications system is shown generally at 110. The communications system 110 includes an elevator car 112 having a camera 130, a speaker 132, a microphone 134, a plurality of activation buttons 138, a processor assembly 150 and a power supply 154. In the illustrated embodiment, the elevator car 112, camera 130, speaker 132, microphone 134, plurality of activation buttons 138, processor assembly 150 and power supply 154 are the same as, or similar to the elevator car 12, camera 30, speaker 32, microphone 34, plurality of activation buttons 38, processor assembly 50 and power supply 54 illustrated in FIG. 2 and described above. However, in other embodiments, the elevator car 112, camera 130, speaker 132, microphone 134, plurality of activation buttons 138, processor assembly 150 and power supply 154 can be different from the elevator car 12, camera 30, speaker 32, microphone 34, plurality of activation buttons 38, processor assembly 50 and power supply 54.

Referring again to FIG. 6, the processor assembly 150 is connected to a cellular modem 160. The cellular modem 160 is configured to connect the communications system 110 to the internet. It should be appreciated that in this embodiment, the cellular modem 160 functions to connect the communications system 110 to the internet, thereby bypassing the local area network. The communications system 110 is configured as an alternative for buildings and facilities that are capable of reliable cellular communications inside of the elevator hoistways.

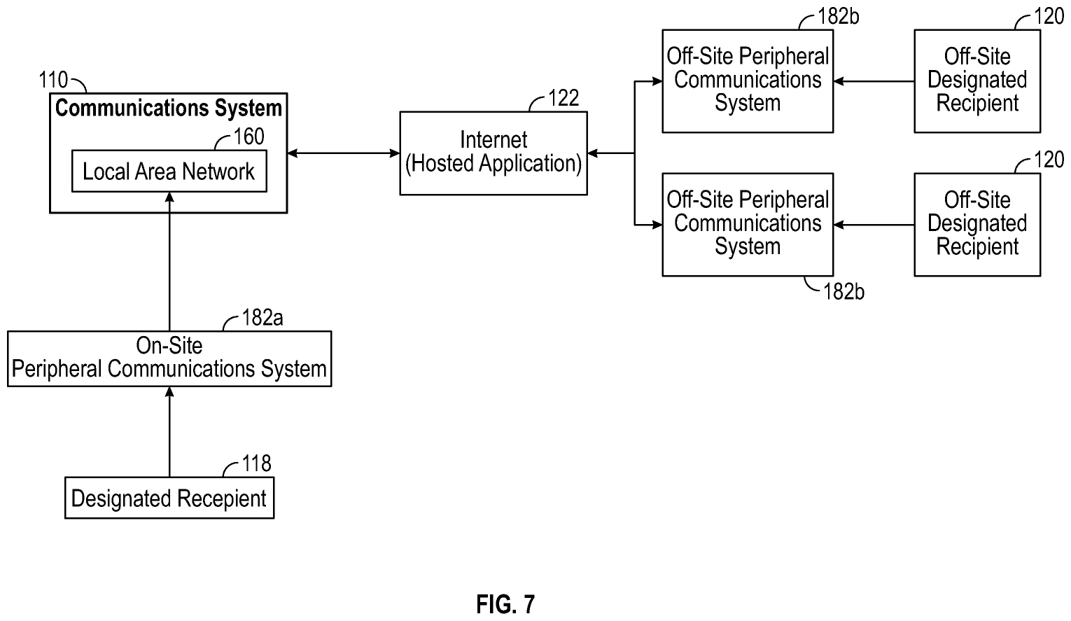

Referring now to FIG. 7, in operation, a peripheral communications system 182, such as the non-limiting examples of a laptop computer or tablet, equipped with proprietary software, accesses a hosted application 122 via the internet. In this manner, the on-site peripheral communications system 182a functions as a user interface for on-site designated recipients 118 to receive real time video, information and communications originating from within the elevator car 112 and communicate to passengers located in the elevator car 112. Simultaneously, offsite peripheral communications system 182b are configured to provide off-site designated recipients 120 to receive real time video, information and communications originating from within the elevator car 112 and communicate to passengers located in the elevator car 112.

The first and second embodiments of the communications system 10, 110 are configured to provide many benefits, although all benefits may not be available in all embodiments. First, the communications systems 10, 110 are configured to provide audible and visual cues while communicating with designated recipients on-site or off-site as required under recent elevator code changes. Second, the communications systems 10, 110 are configured to operate with or without an internet connection. Third, the on-site and off-site peripheral communications systems configured to communicate with multiple cars simultaneously or join existing sessions between elevators and other designated stations on-site. While the communications systems 10, 110 are not configured to communicate with off-site locations when operating in a stand-alone configuration, with an internet connection, as a fourth benefit, communications can be established with off-site locations such as call centers or maintenance service providers. Fifth, off-site users are able to initiate or receive communications with an internet connected communication system using a web browser and minimal system configuration. Finally, the communication system software can be configured as a server application, thereby minimizing resource usage on the client-side devices like laptops, tablets or smartphones.

In accordance with the provisions of the patent statutes, the principle and mode of operation of the elevator-based audio/video/texting emergency communications system have been explained and illustrated in certain embodiments. However, it must be understood that the elevator-based audio/video/texting emergency communications system may be practiced otherwise than as specifically explained and illustrated without departing from its spirit or scope.

1. An elevator-based audio/video/texting emergency communications system configured to facilitate communication between passengers within an elevator car and designated emergency service providers, the elevator-based audio/video/texting emergency communications system comprising:
one or more cameras located within the elevator car and configured to observe an interior space of the elevator car;
one or more speakers located within the elevator car and configured to broadcast audio communication from designated emergency service providers;
one or more microphones located within the elevator car and configured to transmit audio communication from passengers within the elevator car;
one or more displays located within the elevator car and configured to facilitate two-way text communication between designated emergency service providers and passengers located within the elevator car;
a processor assembly configured to receive communication from the one or more cameras, speakers, microphones and displays, and further configured to process the electrical communications thereby allowing electrical connection with other devices;
an elevator car ethernet adapter configured to receive communication from the processor assembly;
a building ethernet adapter configured to receive communication from the elevator car ethernet adapter; and
an ethernet switch configured to receive communication from the elevator car ethernet adapter and further configured to connect to various peripheral communications systems, thereby forming a local area network.

2. The elevator-based audio/video/texting emergency communication system of claim 1, wherein the one or more cameras are configured to observe an interior floor space of the elevator car.

3. The elevator-based audio/video/texting emergency communication system of claim 1, wherein the one or more displays located within the elevator car have the form of touchscreen displays.

4. The elevator-based audio/video/texting emergency communication system of claim 1, wherein the processor assembly has the form of a single board computer.

5. The elevator-based audio/video/texting emergency communication system of claim 1, wherein the processor assembly is positioned on the elevator car.

6. The elevator-based audio/video/texting emergency communication system of claim 1, wherein the designated emergency service providers can be located within a building containing the elevator or exterior to the building containing the elevator.

7. The elevator-based audio/video/texting emergency communication system of claim 1, wherein the ethernet switch is configured to connect to internet access capable devices.

8. An elevator-based audio/video/texting emergency communications system configured to facilitate communication between passengers within an elevator car and designated emergency service providers, the elevator-based audio/video/texting emergency communications system comprising:
one or more cameras located within the elevator car and configured to observe an interior space of the elevator car;
one or more speakers located within the elevator car and configured to broadcast audio communication from designated emergency service providers;
one or more microphones located within the elevator car and configured to transmit audio communication from passengers within the elevator car;
one or more displays located within the elevator car and configured to facilitate two-way text communication between designated emergency service providers and passengers located within the elevator car;
a processor assembly configured to receive communication from the one or more cameras, speakers, microphones and displays, and further configured to process the electrical communications thereby allowing electrical connection with other devices; and
a cellular modem configured to receive communication from the processor assembly and further configured to connect to various peripheral communications systems, thereby forming a local area network.

9. The elevator-based audio/video/texting emergency communication system of claim 8, wherein the one or more cameras are configured to observe an interior floor space of the elevator car.

10. The elevator-based audio/video/texting emergency communication system of claim 8, wherein the one or more displays located within the elevator car have the form of touchscreen displays.

11. The elevator-based audio/video/texting emergency communication system of claim 8, wherein the processor assembly has the form of a single board computer.

12. (canceled)

12. The elevator-based audio/video/texting emergency communication system of claim 8, wherein the designated emergency service providers can be located within a building containing the elevator or exterior to the building containing the elevator.

13. The elevator-based audio/video/texting emergency communication system of claim 8, wherein the cellular modem is configured to connect to internet access capable devices.

14. A method of operating an elevator-based audio/video/texting emergency communications system configured to facilitate communication between passengers within an elevator car and designated emergency service providers, the method comprising:
observing an interior space of an elevator car with one or more cameras located within the elevator car;
broadcasting audio communication from designated emergency service providers with one or more speakers located within the elevator car;
transmitting audio communication from passengers within the elevator car with one or more microphones located within the elevator car;
communicating text between designated emergency service providers and passengers located within the elevator car with one or more displays located within the elevator car;
receiving communication from the one or more cameras, speakers, microphones and displays with a processor assembly, thereby allowing electrical connection with other devices;
receiving communication from the processor assembly with an elevator car ethernet adapter;
receiving communication from the elevator car ethernet adapter with a building ethernet adapter; and
receiving communication from the elevator car ethernet adapter with an ethernet switch and connecting to various peripheral communications systems, thereby forming a local area network.

15. The method of claim 14, including the step of observing an interior floor space of the elevator car.

16. The method of claim 14, wherein the one or more displays located within the elevator car have the form of touchscreen displays.

17. The method of claim 14, wherein the processor assembly has the form of a single board computer.

18. The method of claim 14, including the step of positioning the processor assembly positioned on the elevator car.

19. The method of claim 14, including the step of communicating with designated emergency service providers located exterior to a building containing the elevator.

20. The method of claim 14, including the step of connecting the ethernet switch to internet access capable devices.
